(19) United States
(12) Patent Application Publication
(10) Pub. No.: US 2005/0092580 A1
(43) Pub. Date: May 5, 2005

(54) Conveyor belt transport alignment device, method and system

(76) Inventor: William J. Clemens, Tampa, FL (US)

Correspondence Address: JOHN J. HALAK, 6717 ASHLEY CT, SUITE 101, SARASOTA, FL, 34241, US

(21) Appl. No.: 10/961,494

(22) Filed: Oct. 7, 2004

Related U.S. Application Data
(60) Provisional application No. 60/516,888, filed on Nov. 3, 2003.

(51) Int. Cl. B65G 21/20

(52) U.S. Cl. 198/416; 198/836.3

(57) ABSTRACT

The invention is an alignment device, method and system for use in conjunction with a conveyor system to assure the proper desired alignment and positioning of items being transported on a conveyor belt system in relation to the direction of travel of the said conveyor belt system. The said alignment device, method and system is comprised of a series of resistibly deflectable roller baffle assembly which are positioned along the sides of the said conveyor belt system, and extend pivotally over and into the path of travel of the said conveyor belt, but are deflected toward the edge of the said conveyor belt when contacted items on the conveyor belt, which baffles press against the edges of the items on the conveyor belt and thereby cause the rotational movement of the said items to the desired alignment and positioning. The said alignment device, method and system is particularly applicable to the handling of checked-in baggage in an airport security environment.

### CROSS-REFERENCE TO RELATED APPLICATIONS

This application is the Utility Patent Application arising from that certain Provisional Patent Application Ser. No. 60/516,888, entitled “Baggage Alignment Roller Assembly”, which had been filed by the same sole inventor as herein with the United States Patent and Trademark Office on Nov. 3, 2003, which Provision Application is pending.

### STATEMENT REGARDING FEDERALLY SPONSORED RESEARCH OR DEVELOPMENT

Not Applicable

### REFERENCE TO SEQUENTIAL LISTING, A TABLE OF A COMPUTER PROGRAM LISTING COMPAC DISK APPENDIX

Not Applicable

### BACKGROUND OF INVENTION

The invention is an alignment device, method and system for use in conjunction with a conveyor system to assure the proper desired alignment and positioning of items being transported on a conveyor belt system in relation to the direction of travel of the said conveyor belt system.

The said alignment device, method and system is comprised of a series of resistibly deflectable roller baffle assembly which are positioned along the sides of the said conveyor belt system, and extend pivotally over and into the path of travel of the said conveyor belt, but are deflected toward the edge of the said conveyor belt when contacted items on the conveyor belt, which baffle assembly press against the edges of the items on the conveyor belt and thereby cause the rotational movement of the said items to the desired alignment and positioning.

In a preferred embodiment of the invention, the handling and movement of baggage within an airport environment has been a growing challenge, in light of both the growth of airline passenger volume and the increased concern for security at airports and on aircraft. One development has been the introduction and rapidly expanding use of automated baggage inspection equipment, including such equipment specifically designed for the detection of explosives in checked-in baggage which has been checked-in by passengers about to embark on a commercial airline flight. The optimal efficient use of such equipment is conditioned upon the proper alignment of checked-in baggage as that baggage approaches and is introduced to and enters the said automatic baggage inspection equipment.

The present invention encompasses a device, method and system for the automatic alignment of checked-in baggage in relation to its direction of travel on a conveyor system as that checked-in baggage approaches entry into the automatic baggage inspection equipment. This invention appreciably reduces, and virtually eliminates, blockages of piled-up checked-in baggage which would otherwise occur and which would prevent entry of that checked-in baggage into the said automated baggage inspection equipment. Blockages otherwise caused by that checked-in baggage not having been properly aligned with the entry to that automatic baggage inspection equipment are thus avoided.

The present invention, although described herein in the preferred mode of handling checked-in baggage in an airport security environment, is much broader and also encompasses the alignment of virtually any items or containers being transported on a conveyor belt system.

### BRIEF SUMMARY OF THE INVENTION

The invention is an alignment device, method and system for use in conjunction with a conveyor system to assure the proper desired alignment and positioning of items being transported on a conveyor belt system in relation to the direction of travel of the said conveyor belt system.

The said alignment device, method and system is comprised of a series of resistibly deflectable roller baffle assembly which are positioned along the sides of the said conveyor belt system, and extend pivotally over and into the path of travel of the said conveyor belt, but are deflected toward the edge of the said conveyor belt when contacted items on the conveyor belt, which baffle assembly press against the edges of the items on the conveyor belt and thereby cause the rotational movement of the said items to the desired alignment and positioning.

In a preferred embodiment of the invention, checked-in baggage at an airport is generally a three dimensional container, such as a suitcase, with a height, depth and width, with the depth of the said suitcase being the shortest of these three dimensions, and the height of the said suitcase being the dimension measured from the surface of the said suitcase on which there is a carrying handle attachment location to the surface of the said suitcase opposite thereto, and the width of the said suitcase being the then remaining third dimension of the said suitcase.

While being transported within an airport baggage conveyor system, checked-in baggage is generally in a “lying down position”, in which the carrying handle location is not on the upper most surface of the said checked-in baggage in relation to the said conveyor belt but rather the said checked-in baggage is positioned on it's side on the said conveyor belt system.

The invention is essentially an alignment device, method and system for use in conjunction with a baggage conveyor system in an airport security environment, specifically airline passenger baggage which has been checked-in by the passenger being transported on a conveyor belt system toward an automated baggage inspection device, which in the preferred embodiment is an explosives detection device, which automated baggage inspection device has a baggage entry template which is generally rectangular and which has height and width dimensions, which width dimension is smaller than the largest non-height dimension of most items of checked-in baggage but which width dimension is larger than the smallest non-height dimension of most items of checked-in baggage.

The said alignment device is comprised of a series of resistibly deflectable baffle assembly (constructed of vertically mounted rollers, the rotational axis of which rollers are oriented perpendicular to the surface of the said conveyor belt system), which baffle assembly are positioned along the sides of the said conveyor belt system, and extend pivotally over the path of travel of the said conveyor belt, but are deflected toward the edge of the said conveyor belt when contacted by checked-in baggage on the said conveyor belt, which baffle assemblies press against the edges of the said checked-in baggage on the said conveyor belt, and thereby cause the rotational movement of the said checked-in baggage, resulting in the largest non-height dimension of the said checked-in baggage being parallel to the direction of travel of the said conveyor belt, and the second largest non-height dimension of the said checked-in baggage to be perpendicular to the direction of travel of the said conveyor belt, thus enabling the said checked-in baggage to fit through the aforesaid template of the said automated baggage inspection device.

### BRIEF DESCRIPTION OF THE DRAWINGS

FIG. 1 is a graphical depiction of a passenger and baggage check-in counter at an airport terminal.

FIG. 2 is a depiction of a series of conveyor belts and related equipment showing the movement of checked-in baggage being directed from the baggage check-in area in an airport to automated baggage inspection equipment devices.

FIG. 3 is a depiction of checked-in baggage being conveyed toward an automated baggage inspection equipment device, with said baggage not aligned on the conveyor, thereby causing a blockage at the entry point to the said automated baggage inspection equipment device.

FIG. 4 is a depiction of an item of checked-in baggage being ejected from a main conveyor and being directed to a further conveyor belt, which further conveyor belt is itself directed to one of several automated baggage inspection equipment devices, with said further conveyor belt system having installed at its sides a series of partially deflectable roller baffle assembly.

FIG. 5 is a depiction of the positioning of the said partially deflectable roller baffle assembly installed along the side of the said further conveyor, aligning an item of checked-in baggage as it is transported by the said further conveyor belt toward the automated baggage inspection equipment device.

FIG. 6 is a front view and a side view of the detail of the said partially deflectable roller baffle assembly.

### DETAILED DESCRIPTION OF THE INVENTION

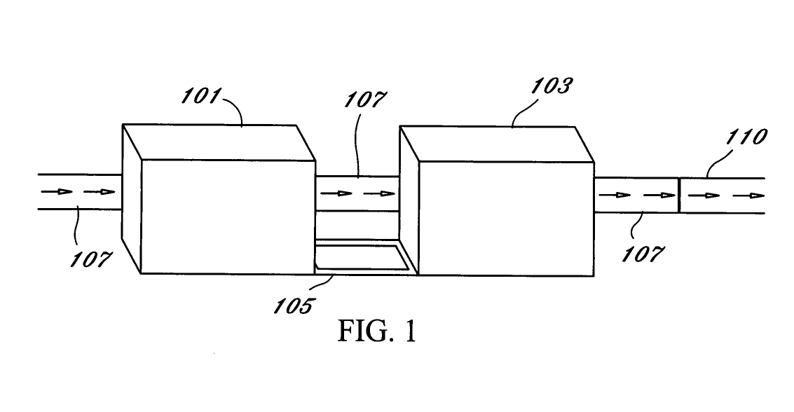

In a preferred embodiment of the invention, FIG. 1 depicts an airline passenger and baggage check-in counter at an airline terminal. The airline agents are present at the check-in counters (101) and (103). The passenger places baggage to be check-in on a weighing sale or other designated surface (105), while the airline agent process the passengers reservation and boarding information, and affixes to the checked-in baggage means for identification of the baggage as being associated with a particular passenger and a particular airline and flight. The agent then places the check-in baggage on the initial conveyor belt (107) behind the check-in counter (101) and (103), and the said baggage is transported on the initial conveyor belt (107) out of the check-in area and onto an intermediary conveyor belt (110).

The intermediary conveyor belt (110) delivers the checked-in baggage to the main conveyor belt (201) where by transfer means (2001) the checked-in baggage is moved from the said intermediary conveyor belt (110) to the said main conveyor belt (201). The said transfer means can be a chute, another conveyor belt, an opening through which the said checked-in baggage is dropped, or other transfer means. Alternatively, the initial conveyor belt (107) and the intermediary conveyor belt (110) can be one and the same.

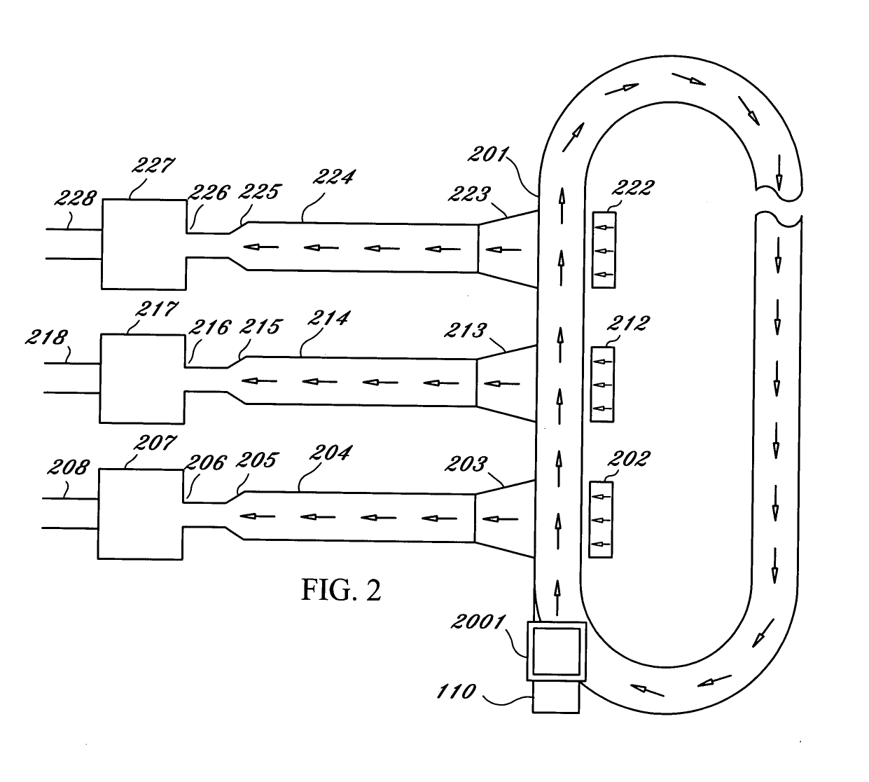

As depicted in FIG. 2, the said checked-in baggage is then further transported on the said secondary conveyor belt (110) within the airport complex through transfer means (2001) onto a main conveyor belt (201). Positioned along the said conveyor (201) are one or more baggage diverter means, shown in FIG. 2 as (202), (212) and (222), by virtue of which checked-in baggage being transported on the main conveyor belt (201) is selectively diverted from the said main conveyor belt (201) onto one of a series of secondary conveyor belts, shown in FIG. 2 as either (204), (214) and (224), respectively. The said main conveyor belt (201) is a closed circuit or loop pattern configuration, so that if an item of checked-in baggage is not diverted from the main conveyor belt (201) by the time it has past the last of the several secondary conveyor belts (204), (214) or (224), the said checked-in baggage is routed back to the first of the said baggage diverter means (202) and goes through the loop again for selective diversion to on of he said secondary conveyor belts (204), (214) or (224). As the checked-in baggage is transported by the main conveyor belt (201), the appropriate baggage diverter means (202), (212) or (222) is electronically instructed by baggage recognition means (which for example could be bar code optical reading apparatus) to activate baggage diverter means (202) if the checked-in baggage is being directed to airline inspected baggage loading area (208), or by baggage diverter means (212) if the checked-in baggage is being directed to airline inspected baggage loading area (218), or by baggage diverter means (222) if the checked-in baggage is being directed to airline inspected baggage loading area (228).

The said baggage diverter means (202), (212) or (222) physically pushes, shoves or otherwise causes the select item of checked-in baggage to be physically diverted from the main conveyor belt (201) to the appropriate one of the said several baggage chutes (203), (213) or (223) associated with the respective secondary conveyor belts (204), (214) or (224).

For example, if an item of checked-in baggage is to be directed to particular airline inspected baggage loading area (208), and is so identified by the diverter activation means, which would occur prior to the checked-in baggage reaching the said checked-in baggage diverter means (202), then as that baggage reaches baggage diverter means (202), that baggage diverter means (202) is activated and it causes the said item of checked-in baggage to be diverted from the main conveyor belt (201) onto chute (203), through which chute the baggage slides onto secondary conveyor (204).

At the time that the said baggage reaches secondary conveyor belt (204), and is then transported on secondary conveyor belt (204) from the main conveyor belt (201) toward the automated baggage inspection equipment device (207), the alignment of the said baggage is not oriented in any particular direction. However, the alignment of said baggage in a particular direction is necessary by virtue of the fact that the said secondary conveyor belt (204) transports the said checked-in baggage to an automated baggage inspection device (207), which in this embodiment is, for purposes of example but not restriction, a device for the detection of explosive material contained within an item of baggage.

The configuration of the point of entry (206) of checked-in baggage into the said automated baggage inspection device (207) is, due to the size of the said automated baggage inspection device (207), of a smaller width dimension than the width of the secondary conveyor belt (204). In FIG. 2, the means for transitioning from the width of the secondary conveyor belt (204) to the width of the point of entry (206) into the automated baggage inspection device (207) is funnel means, such as narrowing or tapered walls or sides (205) of the said secondary conveyor belt system.

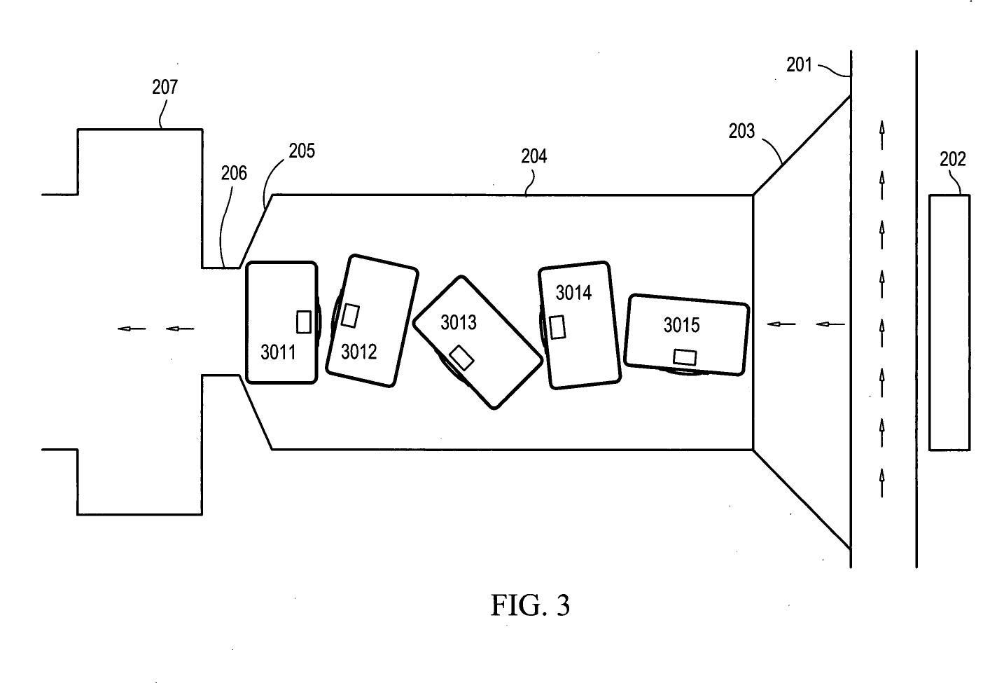

FIG. 3 depicts several items of checked-in baggage (3011), (3012), (3013), (3014) and (3015), being transported on secondary conveyor belt (204) from the main conveyor (201), with the said items of checked-in baggage not having been aligned on the secondary conveyor (204). The resultant random (non-aligned) positioning of the said checked-in baggage would result in blockage to the entry (206) to the automated baggage inspection equipment device (207), which blockage would shut down the secondary conveyor belt (204) and would need to be manually cleared, incurring expense and delay.

The present invention is a device, method and system by virtue of which checked-in baggage being transported on secondary conveyor (204) toward the point of entry (206) into the automated baggage inspection device (207) is automatically oriented in relation to the direction of travel of the said secondary conveyor belt so that the shortest non-height dimension of the said checked-in baggage is aligned to be perpendicular to the direction of travel of the said secondary conveyor belt (204) and the longest non-height dimension of the said checked-in baggage is aligned to be parallel with the direction of travel of the said secondary conveyor belt (204).

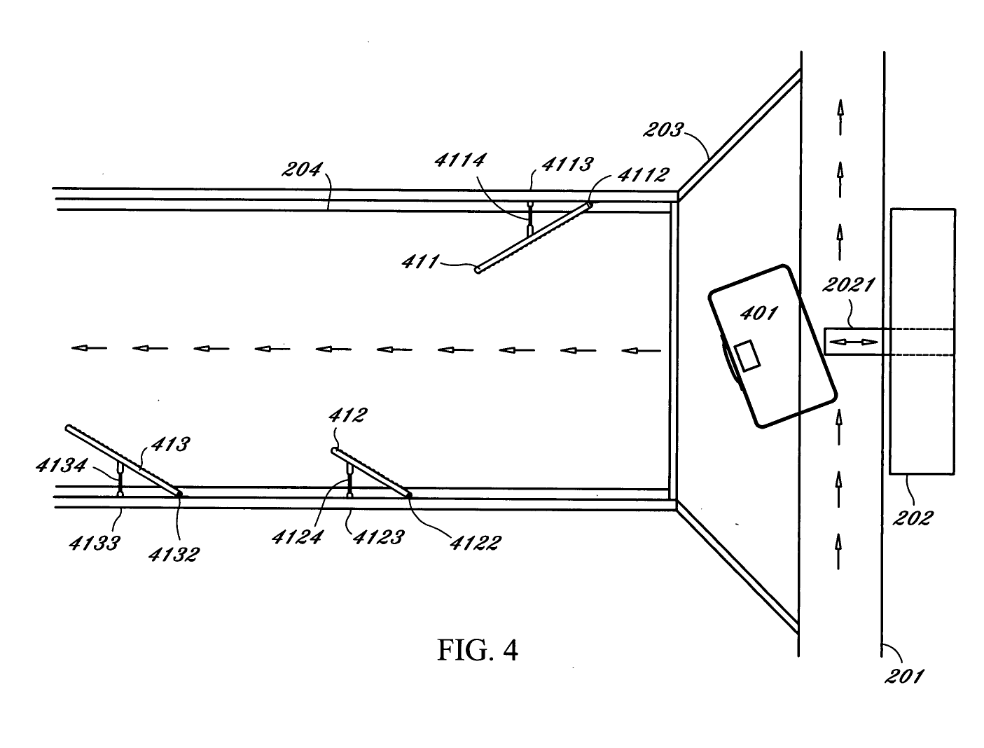

Checked-in baggage, shown in FIG. 4 as (401), being transported on the said main conveyor belt (202) is electronically identified to be diverted to secondary conveyor belt (204) destined to airline inspected baggage loading area (208) and is thus by diversion activation means (2021) of baggage diverter means (202), in which diversion activation means (2021) mechanically extends on command from baggage diversion means (202) to push, shove or otherwise cause checked-in baggage (401) to be diverted from main conveyor belt (201) to chute (203) and to slide down chute (203) onto secondary conveyor belt (204). Baggage (401) is then transported on secondary conveyor (204), in the direction away from chute (203).

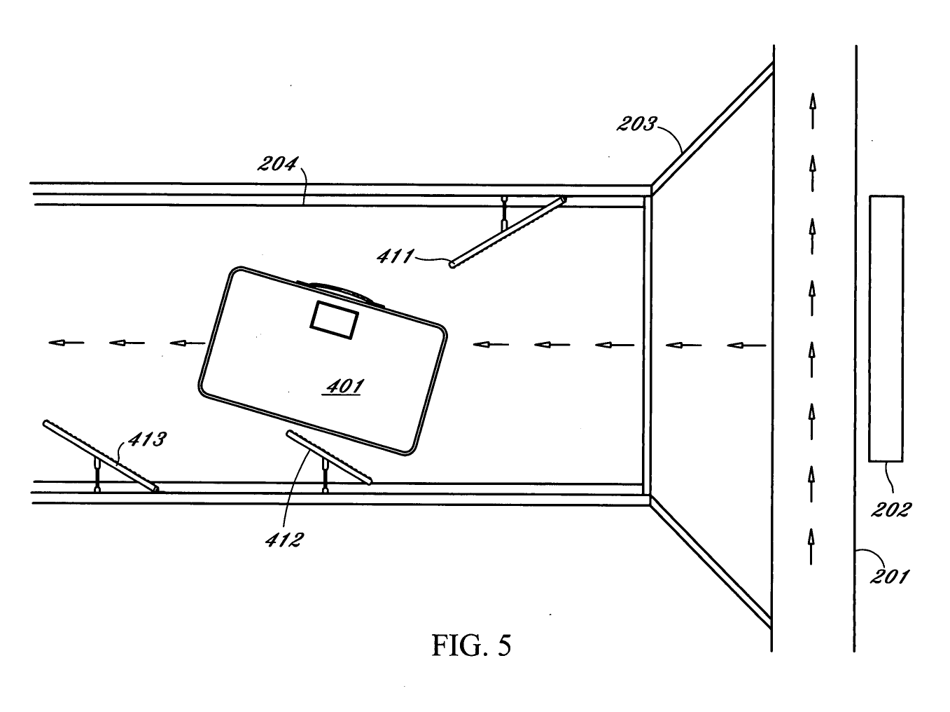

As shown particularly in FIG. 4 and FIG. 5, the said alignment of the said checked-in baggage (401) on the said secondary conveyor belt (204) is accomplished by a series of three partially deflectable roller baffle assembly, as depicted as (411), (412) and (413), respectively, positioned along the sides of the said secondary conveyor belt (204).

The first partially deflectable roller baffle assembly (411) is affixed to a wall on the side of, and parallel, to secondary conveyor belt (204) at rotational connection point (4112), with the said first partially deflectable roller baffle assembly (411) being partially rotational around the said first rotational connection point (4112).

The said first partially deflectable roller baffle assembly (411) is further affixed to the same wall on the side of, and parallel, to secondary conveyor belt (204) at fixed connection point (4113) by partially deflectable connecting means (4114), which connects the said first partially deflectable roller baffle assembly (411) to the said wall.

The said partially deflectable connecting means (4114) can be and include numerous methods and devices, such as springs, cushions, hydraulic or pneumatic shock absorber type devices.

The second partially deflectable roller baffle assembly (412) is affixed to a wall, on the opposite side of the secondary conveyor belt (204) wall to which the first partially deflectable roller baffle assembly. (411) is affixed, at rotational connection point (4122), with the said second partially deflectable roller baffle assembly (412) being partially rotational around the said second rotational connection point (4122).

The said second partially deflectable roller baffle assembly (412) is further affixed to the same wall on the side of, and parallel, to secondary conveyor belt (204) at fixed connection point (4223) by partially deflectable connecting means (4124), which connects the said second partially deflectable roller baffle assembly (412) to the said wall.

The said partially deflectable connecting means (4124) can be and include numerous methods and devices, such as springs, cushions, hydraulic or pneumatic shock absorber type devices.

The third partially deflectable roller baffle assembly (413) is affixed to a wall, on the same side of the secondary conveyor belt (204) wall to which the second partially deflectable roller baffle assembly (412) is affixed, at rotational connection point (4132), with the said third partially deflectable roller baffle assembly (413) being partially rotational around the said second rotational connection point (4132).

The said third partially deflectable roller baffle assembly (413) is further affixed to the same wall on the side of, and parallel, to secondary conveyor belt (204) at fixed connection point (4233) by partially deflectable connecting means (4134), which connects the said third partially deflectable roller baffle assembly (413) to the said wall.

The said partially deflectable connecting means (4134) can be and include numerous methods and devices, such as springs, cushions, hydraulic or pneumatic shock absorber type devices.

As shown in FIG. 5, while being so transported, checked-in baggage (401) encounters and comes into contact with the first partially deflectable roller baffle assembly (411), which causes the said baggage (401) to be partially aligned, so that the longest dimension of the said baggage approaches being aligned with the direction of travel of the said secondary conveyor.

As the said baggage (401) continues to be transported by the said secondary conveyor belt (204), past the said first partially deflectable roller baffle assembly (411), that said checked-in baggage (401) encounters and comes into contact with the second partially deflectable roller baffle assembly (412). The said second partially deflectable roller baffle assembly (412) is approximately three quarters the length of the first partially deflectable roller baffle assembly (411) and is also approximately three quarters the length of the third partially deflectable roller baffle assembly (413) discussed below, with the said the third partially deflectable roller baffle assembly (413) being the same length as the said first partially deflectable roller baffle assembly (411). That said encounter of the checked-in baggage (401) with the second partially deflectable roller baffle assembly (412) causes the said checked-in baggage (401) to be further aligned, so that the longest dimension of the said checked-in baggage (401) approaches being aligned with the direction of travel of the said secondary conveyor belt (204).

As the said checked-in baggage (401) continues to be transported by the said secondary conveyor belt (204), past the said second partially deflectable roller baffle assembly (412), that said checked-in baggage (401) encounters and comes into contact with the third partially deflectable roller baffle assembly (413). That said encounter of the checked-in baggage (401) with the said third partially deflectable roller baffle assembly (413) causes the said checked-in baggage (401) to be even further aligned, so that the longest dimension of the said checked-in baggage (401) is essentially fully aligned with the direction of travel of the said secondary conveyor belt (204).

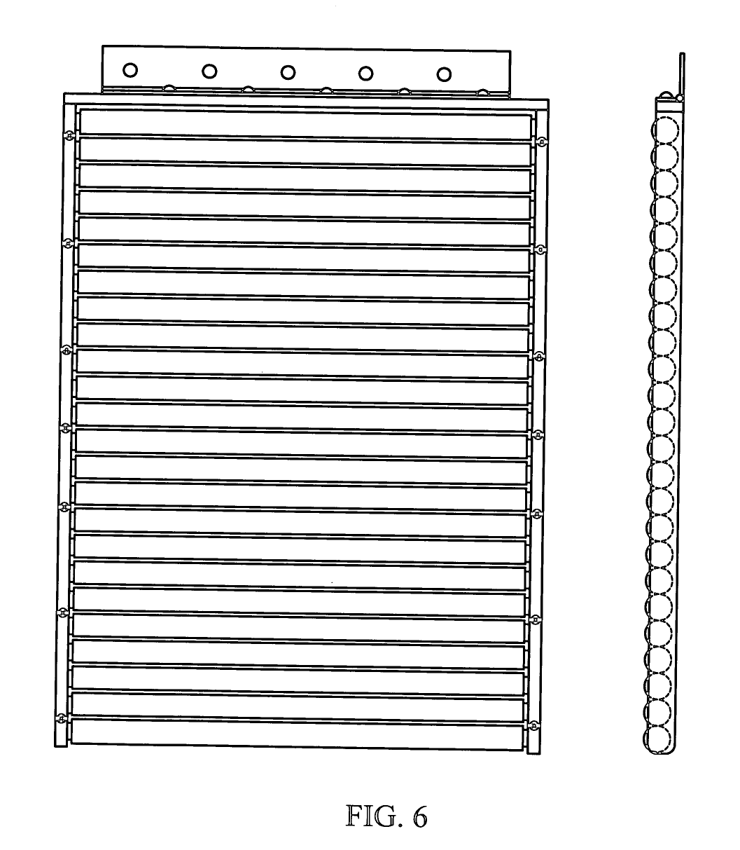

FIG. 6 is a presentation of a typical partially deflectable roller baffle assembly, showing both the front view and the side view.

It has been determined that the use of fewer than three partially deflectable roller baffle assembly is substantially less effective in aligning the checked-in baggage (401) with the direction of travel of the said secondary conveyor belt (204), whereas the use of more that three partially deflectable roller baffle assembly does not appear to enhance the alignment of the checked-in baggage (401) with the direction of travel of the said secondary conveyor belt (204).

Similarly it has also been determined that the length of the second partially deflectable roller baffle assembly (412) being approximately three quarters the length of the first partially deflectable roller baffle assembly (421) and the third partially deflectable roller baffles assembly (413) maximizes the alignment of the checked-in baggage (401) with the direction of travel of the said secondary conveyor (204).

Furthermore, it has also been determined that the diameter of the rollers which comprise the partially deflectable roller baffles assembly impacts the effectiveness of the alignment of the checked-in baggage (401) on the secondary conveyor belt (204). Specifically, the larger the diameter of the said rollers, the greater the likelihood that the corners of the checked-in baggage (401) will become trapped between two adjacent rollers, causing the said checked-in baggage (401) to fail to properly align on the secondary conveyor belt (204).

In addition, it has been determined that the alignment of the checked-in baggage (410) in being conveyed on the second conveyor belt (204) is optimized if the distance between said first rotational connection point (421) and the second said rotational point (422) is three to for feet, and when the distance between the said second rotational point (422) and the said third rotational point (423) is also between three to four feet.

It has also been determined that the said roller baffles need to partially deflectable to achieve the alignment of the checked-in baggage (401) with the direction of travel of the secondary conveyor belt (204).

If the said roller baffles assembly are not deflectable at all, that is if they completely and immovably resist the encounter the checked-in baggage (401) on the second conveyor belt (204), alignment of that checked-in baggage (401) with the direction of travel of the said secondary conveyor belt (204) is appreciably reduced.

Similarly, if the said roller baffle assemblies are totally deflectable, that is, if they are completely movable by the encounter with the checked-in baggage (401) on the second conveyor belt (204), alignment of that checked-in baggage (401) with the direction of travel of the said secondary conveyor belt (204) is also appreciably reduced.

Although the means of causing the said roller baffle assemblies to be partially deflectable can include numerous devices and methods, such as springs or cushions, it has been determined that the use of hydraulic or pneumatic devices, such as shock absorbers, is optimally effective in maximizing the alignment of the said baggage with the direction of travel of the said secondary conveyor belt.

It is contemplated that the inventive concepts herein described may be variously otherwise embodied and it is intended that the appended claims be construed to include and encompass alternate embodiments of the invention except only insofar as limited by prior art.

1. a device for the alignment of items being transported on a conveyor belt, comprising:
a first partially deflectable roller baffle assembly which is vertically positioned along one side edge of a conveyor belt, which conveyor belt transports items, which said partially deflectable roller baffle assembly is constructed of a row of vertically mounted rollers, the rotational axis of which rollers is oriented perpendicular to the surface of the said conveyor belt, which said partially deflectable roller baffle assembly extends pivotally over the path of travel of the said conveyor belt, but which is partially deflectable toward the edge of the said conveyor belt when contacted by any item being transported on the said conveyor belt, which said contact causes the said item to be aligned in the direction of travel of the said conveyor belt;
a second partially deflectable roller baffle assembly which is vertically positioned along the other side edge of the said conveyor belt, which said other side edge is opposite to the side edge of the said conveyor belt at which the said first partially deflectable roller baffle assembly is positioned, which conveyor belt transports items, which said partially deflectable roller baffle assembly is constructed of a row of vertically mounted rollers, the rotational axis of which rollers is oriented perpendicular to the surface of the said conveyor belt, which said partially deflectable roller baffle assembly extends pivotally over the path of travel of the said conveyor belt, but which is partially deflectable toward the edge of the said conveyor belt when contacted by any item being transported on the said conveyor belt, which said contact causes the said item to be aligned in the direction of travel of the said conveyor belt; and
a third partially deflectable roller baffle assembly which is vertically positioned along the same side edge of the said conveyor belt at which the said second partially deflectable roller baffle assembly is positioned, which conveyor belt transports items, which said partially deflectable roller baffle assembly is constructed of a row of vertically mounted rollers, the rotational axis of which rollers is oriented perpendicular to the surface of the said conveyor belt, which said partially deflectable roller baffle assembly extends pivotally over the path of travel of the said conveyor belt, but which is partially deflectable toward the edge of the said conveyor belt when contacted by any item being transported on the said conveyor belt, which said contact causes the said item to be aligned in the direction of travel of the said conveyor belt.

2. The device of claim 1 in which the said item being transported on a conveyor belt is passenger baggage checked-in at an airport environment for loading onto an airline.

3. The device of claim 1 in which the length of the said second partially deflectable roller baffle assembly is approximately three quarters of the length of the said first partially deflectable roller baffle assembly, and the length of the said third partially deflectable roller baffle assembly is the same as the length of the said first partially deflectable roller baffle assembly.

4. A device for the alignment of items of rectangular shaped baggage, or trays carrying baggage, being transported on a conveyor belt toward an opening into an item of automated baggage inspection equipment, which opening is wider than the smallest non-height dimension of said baggage or baggage tray, but is narrower than the largest non-height dimension of said baggage or baggage tray, comprising:
a first partially deflectable roller covered baffle vertically positioned along one edge of a conveyor belt assembly, which conveyor belt assembly transports baggage checked with an airline at an airport, which baffle is constructed of vertically mounted rollers, the rotational axis of which rollers are oriented perpendicular to the surface of the said conveyor belt, which baffle extends pivotally over the path of travel of the said conveyor belt, but which is partially deflectable toward the edge of the conveyor belt when contacted by baggage or a baggage tray on the conveyor belt, causing the longest dimension of the said baggage or baggage tray to be more closely aligned with the direction of travel of the said conveyor belt;
a second partially deflectable roller covered baffle vertically positioned along one edge of a conveyor belt assembly, opposite to the edge of the baffle of the said first baffle, and of a length extended across the said conveyor belt which is approximately half of that of that of the said first baffle, which conveyor belt assembly transports baggage checked with an airline at an airport, which baffle is constructed of vertically mounted rollers, the rotational axis of which rollers are oriented perpendicular to the surface of the said conveyor belt, which baffle extends pivotally over the path of travel of the said conveyor belt, but which is partially deflectable toward the edge of the conveyor belt when contacted by baggage or a baggage tray on the conveyor belt, causing the longest dimension of the said baggage or baggage tray to be even more closely aligned with the direction of travel of the said conveyor belt; and
a third partially deflectable roller covered baffle vertically positioned along one edge of a conveyor belt assembly, on the same side of the said conveyor as the said second baffle, and of a length extended across the said conveyor belt which is approximately equal to that of he said first baffle, which conveyor belt assembly transports baggage checked with an airline at an airport, which baffle is constructed of vertically mounted rollers, the rotational axis of which rollers are oriented perpendicular to the surface of the said conveyor belt, which baffle extends pivotally over the path of travel of the said conveyor belt, but which is partially deflectable toward the edge of the conveyor belt when contacted by baggage or a baggage tray on the conveyor belt, causing the longest dimension of the said baggage or baggage tray to be even more closely aligned with the direction of travel of the said conveyor belt, thus enabling the said baggage or baggage tray to enter into the opening of the said automatic baggage inspection equipment.

5. A method for aligning items being transported on a conveyor belt, comprising the steps of:
transporting items on a conveyor belt;
passing the said items, while on the moving conveyor belt, through a series of partially deflectable roller baffle assemblies; and
impacting the said items being so transported on the conveyor belt by the said partially deflectable roller baffle assemblies.

6. A system for aligning items being transported on a conveyor belt, comprising:
means for transporting items on a conveyor belt;
means for causing the said items being transported on a conveyor belt to pass through a series of partially deflectable roller baffle assemblies; and
means for the said items to be physically contacted by the said series of partially deflectable roller baffle assemblies.
